(19) United States
(12) Patent Application Publication
(10) Pub. No.: US 2026/0233553 A1
(43) Pub. Date: Aug. 13, 2026

(54) SPLINE JOINT SEAL AND RETAINER

(71) Applicant: Schaeffler Technologies AG & Co. KG, Herzogenaurach (DE)

(72) Inventors: Joseph Robinson, Winona, MN (US); Halia Andrews, Clarkston, MI (US); Michael Eastman, Petersburg, MI (US); Shakeel Shaikh, Windsor (CA); Victoria Poole, Livonia, MI (US)

(73) Assignee: Schaeffler Technologies AG & Co. KG, Herzogenaurach (DE)

(21) Appl. No.: 19/397,265

(22) Filed: Nov. 21, 2025

Related U.S. Application Data
(60) Provisional application No. 63/725,094, filed on Nov. 26, 2024.

(51) Int. Cl. B60B 27/00

(52) U.S. Cl. CPC B60B 27/0073; B60B 27/0005; B60B 27/0031

(57) ABSTRACT

A wheel bearing assembly includes a wheel hub, a joint element, a first retaining element, and a second retaining element. The wheel hub and the joint element form an axial face spline joint. The axial face spline joint is held together via the first retaining element and the second retaining element before a fastener is installed.

### CROSS-REFERENCE TO RELATED APPLICATIONS

This application claims priority to U.S. Provisional Application 63/725,094 filed Nov. 26, 2024, the entire disclosure of which is incorporated by reference herein.

### TECHNICAL FIELD

The present disclosure is generally related to a wheel bearing assembly of a vehicle. Specifically, the disclosure relates to retention of a wheel bearing assembly to a constant velocity (CV) joint during an assembly process.

### BACKGROUND

Wheel bearing assemblies are widely used within the vehicle industry for rotatably supporting a driving wheel of a vehicle.

### SUMMARY

Example embodiments of the present disclosure provide a wheel bearing assembly that includes a wheel bearing and a joint element. The wheel bearing includes: i). an inner ring, ii) an outer ring, iii) at least one row of rolling elements arranged within a rolling element space defined by the inner ring and the outer ring, iv) a first central axis, v) a first axial face spline, and vi) a first retaining element fixed to the wheel bearing. The joint element includes a second central axis and a second axial face spline that non-rotatably engages with first axial face spline to form an axial face spline joint. A second retaining element is located radially between the joint element and the wheel bearing which axially retains the wheel bearing to the joint element. The first retaining element abuts with the joint element to limit a tilt angle between the first central axis and the second central axis.

In an example embodiment, the first retaining element comprises a sleeve fixed to a hub of the wheel bearing. An end of the sleeve can abut with the joint element to limit the tilt angle between the first central axis and the second central axis.

In an example embodiment, the first retaining element includes a first sealing lip that sealingly engages a radial surface of the joint element. The first retaining element can also include a second sealing lip that sealingly engages an axial surface of a magnetic encoder.

In an example embodiment, the second retaining element is a retaining ring disposed radially between the wheel bearing and the joint element; in a further aspect, the second retaining element springably couples the joint element to the wheel bearing and is arranged radially inwardly of the first retaining element.

In an example embodiment, a first seal is arranged at an axial inner portion of the rolling element space and a second seal is arranged at an axial outer portion of the rolling element space.

In an example embodiment, the joint element further comprises a male portion that is disposed within a female portion of the wheel bearing, and the second retaining element is disposed radially between the male portion and the female portion to axially retain the wheel bearing to the joint element.

In an example embodiment, the wheel bearing assembly includes a fastener that rotationally, pivotably, and axially fixes the wheel bearing to the joint element. In a further aspect, the fastener can be concentric with the first central axis.

In an example embodiment, the joint element can be a constant velocity joint.

In an example embodiment, a distal end of the first retaining element defines a gap with the surface, and the gap defines a tilt angle between the first central axis and the second central axis.

An example embodiment of a method for assembling a wheel bearing to a joint element is provided. The method includes providing four components. The first component is a wheel bearing that has a hub, at least one row of rolling elements arranged within a rolling element space defined by an inner ring and an outer ring. The hub is attached to a wheel and includes a first axial face spline. The second component is a first retaining element fixed to the wheel bearing. The third component is a joint element that has a second axial face spline. The fourth component is a second retaining element that is fixed to either the hub or the joint element. The method also includes inserting the joint element into the hub so that: i) the second axial face spline is non-rotatably engaged with the first axial face spline to form an axial face spline joint; ii) the second retaining element locks the joint element to the hub so as to axially retain the joint element to the hub, and iii) an end of the first retaining element is proximate to or engaged with an outer surface of the joint element in order to limit a tilt angle between a central axis of the joint element relative to a central axis of the wheel bearing. After axial and tilt retention is in place for the axial face spline joint via the first and second retaining elements, the method further includes fixing the wheel bearing to the joint element via a fastener disposed within the bore.

In an example embodiment, the first retaining element and the second retaining element are non-threaded.

In an example embodiment, the first retaining element includes a first sealing lip configured to seal the axial face spline joint.

In an example embodiment, the first retaining element is fixed to a ring of the wheel bearing, and the ring includes a raceway. In a further aspect, fixation occurs via a press-fit.

An example embodiment of a wheel bearing is provided that includes a wheel bearing with a first axial face spline, a joint element with a second axial face spline, a first retaining element, a second retaining element, and a fastener. The first retaining element axially retains the joint element to the wheel bearing. The second retaining element limits a relative pivot motion between the joint element and the wheel bearing. The fastener fixes the joint element to the wheel bearing.

### BRIEF DESCRIPTION OF THE DRAWINGS

FIG. 1 shows a perspective view of an example embodiment of a wheel bearing and constant velocity (CV) joint assembly that includes a spline joint seal retainer.

FIG. 2 shows a cross-sectional view taken from FIG. 1.

FIG. 3A shows a cross-sectional view taken from FIG. 1.

FIG. 3B shows a cross-sectional view taken from FIG. 1.

FIG. 4 is a detailed view taken from FIG. 3A.

FIG. 5 shows a cross-sectional view of an example embodiment of a spline joint seal and retainer together with the wheel bearing and CV joint assembly of FIG. 1.

FIG. 6 shows a perspective view of the spline joint seal and retainer of FIG. 4.

FIG. 7 shows a perspective view of the spline joint seal and retainer of FIG. 4.

FIG. 8 shows a cross-sectional view taken from FIG. 6.

FIG. 9 shows a detailed view taken from FIG. 8.

FIG. 10 shows a schematic view of an angle that can occur between respective central axes of the wheel bearing and CV joint of FIG. 1 during an assembly process.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The term “non-rotatably engage” is meant to signify two elements that are connected in a way that whenever one of the elements rotate, both of the elements rotate in unison, such that relative rotation between these elements is not possible.

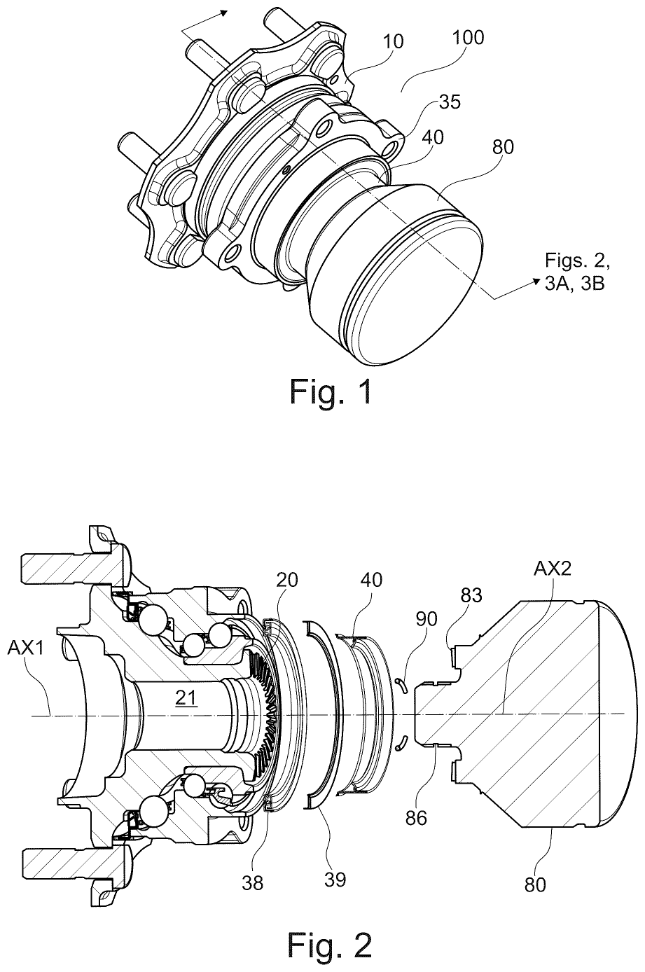

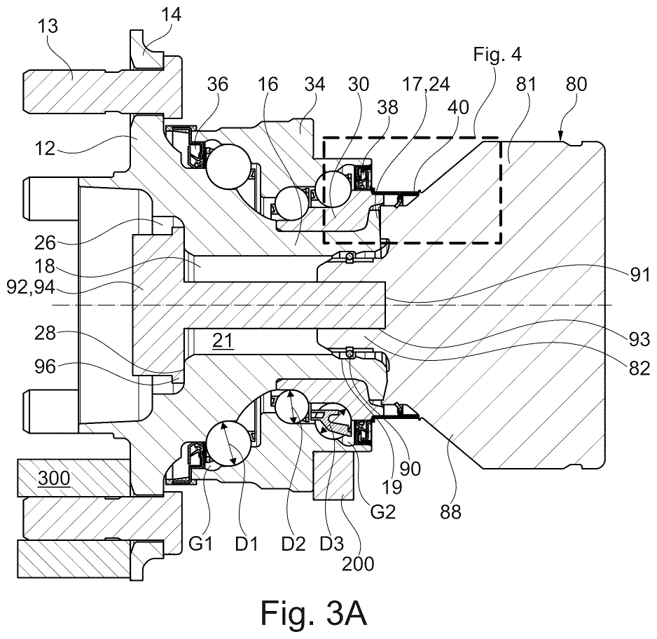

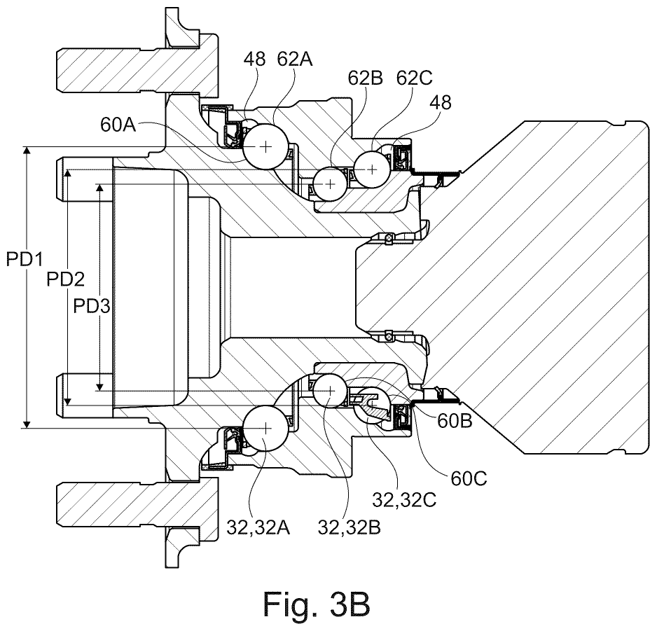

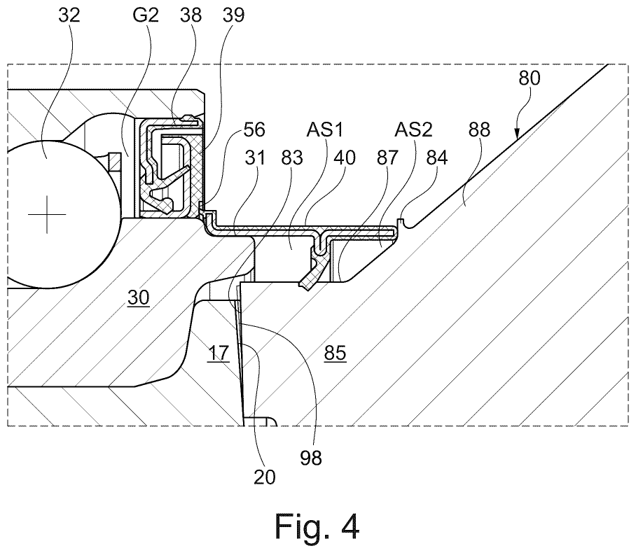

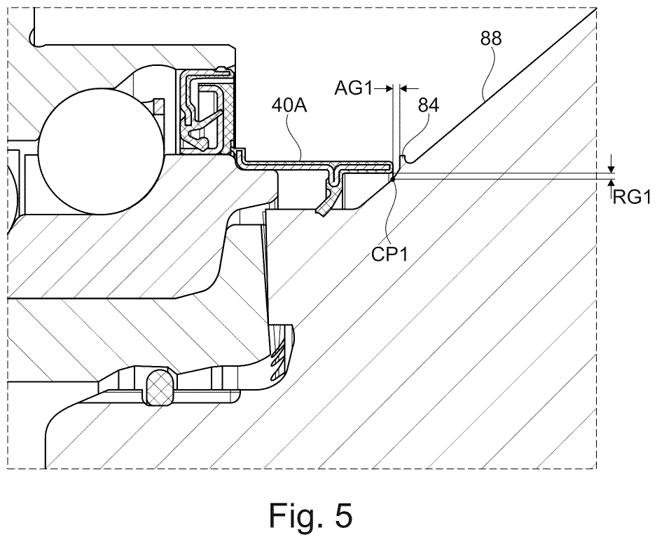

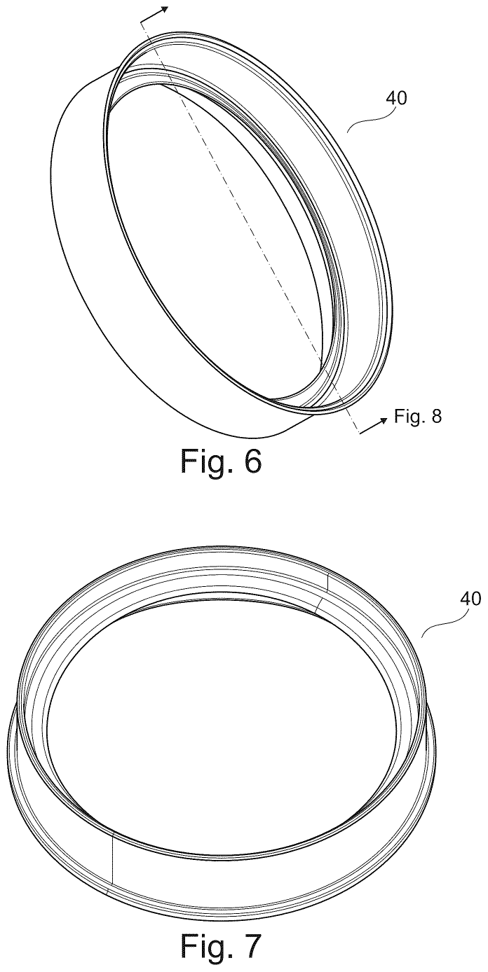

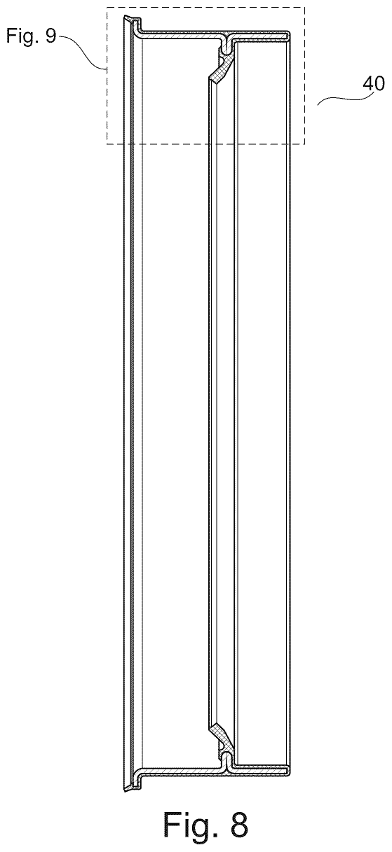

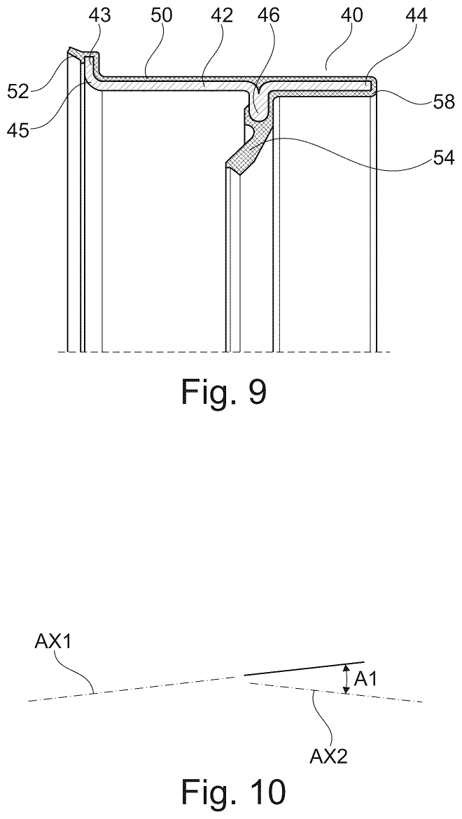

FIG. 1 shows a perspective view of an example embodiment of a wheel bearing and constant velocity (CV) joint assembly 100 that includes a spline joint seal and retainer (SJSR) 40. FIGS. 2, 3A, and 3B show cross-sectional views taken from FIG. 1. FIG. 4 is a detailed view taken from FIG. 3A, showing a cross-sectional view of the SJSR 40 together with the wheel bearing and CV joint assembly 100 of FIG. 1. FIG. 5 shows a cross-sectional view of an example embodiment of an SJSR 40A together with the wheel bearing and CV joint assembly 100. FIGS. 6 and 7 show perspective views of the SJSR 40. FIG. 8 shows a cross-sectional view of the SJSR 40 taken from FIG. 6. FIG. 9 shows a detailed view of the SJSR 40 taken from FIG. 8. FIG. 10 shows a schematic view of an angle A1 that can occur between respective central axes AX1, AX2 of the wheel bearing 10 and the CV joint 80 during an assembly process. The following should be read in light of FIGS. 1 through 10.

A wheel bearing 10 and a CV joint 80 form the wheel bearing and CV joint assembly 100. The wheel bearing 10 includes a hub 12 that includes a separate inner ring 30, a separate outer ring 34, and rolling elements 32 disposed therebetween. The outer ring 34 is fixed to a chassis 200 of a vehicle via apertures arranged within radially extending protrusions 35. The outer ring 34 and the inner ring 30 and hub 12 define a rolling element space 48. An axial outer portion of the rolling element space 48 (between the outer ring and the hub 12) defines a first gap G1 and an axial inner portion of the rolling element space 48 (between the outer ring 34 and the inner ring 30) defines a second gap G2. A first seal 36 is disposed in the first gap G1 and a second seal 38 is disposed in the second gap G2. It could be stated that all of the rolling element raceways and corresponding rolling elements reside axially between the first and second seals 36, 38. The hub 12 further includes a flange portion 14 and a nose portion 16. The flange portion 14 is fixed to a wheel 300 of the vehicle via fasteners 13. The nose portion 16, which could be described as a cylindrical extension, is cylindrical in shape and has a flange 17 disposed at a distal end 24. The flange 17 includes a first axial face spline 20. A through-bore 18 extends through the hub 12.

The wheel bearing 10 includes: i) a first plurality of rolling elements 32A that define a first pitch circle diameter PD1, ii) a second plurality of rolling elements 32B that define a second pitch circle diameter PD2, and iii) a third plurality of rolling elements 32C that define a third pitch circle diameter PD3. In an example embodiment, the first, second, and third pitch circle diameters PD1, PD2, PD3 are all different from each other. The first plurality of rolling elements 32A rollably engage a first inner raceway 60A integrated on the hub 12 and a first outer raceway 62A integrated on the outer ring 34. The second plurality of rolling elements 32B rollably engage a second inner raceway 60B integrated on the inner ring 30 and a second outer raceway 62B integrated on the outer ring 34. The third plurality of rolling elements 32C rollably engage a third inner raceway 60C integrated on the inner ring 30 and a third outer raceway 62C integrated on the outer ring 34.

Each of the first plurality (or first row) of rolling elements 32A define a first ball diameter D1; each of the second plurality (or second row) of rolling elements 32B define a second ball diameter D2; and each of the third plurality (or third row) of rolling elements 32C define a third ball diameter D3. In an example embodiment, the first, second, and third ball diameters D1, D2, D3 are all different from each other. Further example embodiments of the wheel bearing 10 may include more or less than three rows of rolling elements, and at least some of the rows may define a same pitch circle diameter.

The CV joint 80 includes a cylindrical segment 81 (truncated within the figures) and a cylindrical nose 82 (or male portion) that is received by the through-bore 18 (or female portion) of the hub 12. A tapered outer surface 88 (or conical outer surface) serves as a transition between the cylindrical nose 82 (smaller diameter) and the cylindrical segment 81 (larger diameter). An axial boss 85 is formed between the cylindrical nose 82 and the cylindrical segment 81 at a base or smaller diameter portion of the tapered outer surface 88. The axial boss 85 includes a second axial face spline 83 that is configured to mesh with or non-rotatably engage with the first axial face spline 20 of the hub 12. As known in the field of wheel bearings, the second axial face spline 83 is similar and complementary to the first axial face spline 20, and thus, its toothed appearance is the same as that shown for the first axial face spline 20 in FIG. 2. It could be stated that the first axial face spline 20 and the second axial face spline 83 together form an axial face spline joint 98. The cylindrical nose 82 includes an annular groove 86 formed on an outer surface.

A retaining ring 90 provides axial retention of the CV joint 80 to the hub 12 and, therefore, can be elastic or resilient in nature to facilitate an assembly process of the CV joint 80 to the hub 12. In an example embodiment, the retaining ring 90 is a known C-shaped ring with a circumferential space between its ends (see FIG. 2). The retaining ring 90 could be replaced with any suitable shape that accomplishes axial retention of the CV joint 80 to the hub 12 and does not have to be ring-shaped. Therefore, the retaining ring 90 could be referred to as a retaining element.

In an example embodiment, the retaining ring 90 is installed on the annular groove 86 of the cylindrical nose 82 of the CV joint 80. During the assembly process of the CV joint 80 to the hub 12, when the cylindrical nose 82 is inserted into the through-bore 18 of the hub, the retaining ring 90 is compressed via a radial inner surface 21 of the through-bore 18. As the cylindrical nose 82 is inserted further into the through-bore 18 in an axial direction, the retaining ring 90 slidably engages the radial inner surface 21. When the retaining ring 90 reaches an annular groove 19 formed on the radial inner surface 21, the retaining ring 90 springably expands radially outwardly into the annular groove 19. Stated otherwise, the retaining ring 90 snaps into or locks into the annular groove 19 to provide axial retention of the CV joint 80 to the hub 12.

In an example embodiment, the retaining ring 90 is installed on the annular groove 19 of the through-bore 18 of the hub 12. When the cylindrical nose 82 is slidably inserted into the through-bore 18, the retaining ring 90 springably engages or snaps into the annular groove 86 of the cylindrical nose 82 to provide axial retention of the CV joint 80 to the hub 12.

Turning to FIG. 10, in addition to the axial retention provided by the retaining ring 90 and corresponding annular grooves 19, 86, the SJSR 40 fixed to the wheel bearing 10 also provides axial retention while limiting a relative tilting angle A1 that can occur between the first central axis AX1 (or rotational axis) of the wheel bearing 10 and the second central axis AX2 (or rotational axis) of the CV joint 80. Excessive tilting between the first and second axes can lead to separation and, thus, disengagement between the first and second axial face splines 20, 83 during the assembly process before a bolt 92 is installed. Given this functionality, the SJSR 40 could also be referred to as a retaining element that pivotably retains the CV joint 80 to the wheel bearing 10.

Turning to FIG. 9, the SJSR 40 has a metal base portion 42 partially surrounded by an elastomer portion 50. The metal base portion 42 can be shaped as a sleeve, as shown in the Figures, however, any suitable shape can be utilized. The SJSR 40 has a first end 43 and a second end 44. At the first end 43, the metal base portion is formed with a flange 45. The flange 45 is partially covered with the elastomer portion 50 so as to form a first sealing lip 52. The first sealing lip 52 seals against an axial surface 56 formed by a magnetic rotary encoder ring (MRER) 39 integrated within the second seal 38 so as to prevent contaminants and moisture from entering. The MRER 39 rotates together with the wheel 300 that is attached to the hub 12. An ABS sensor (not shown) detects a variation of magnetic poles on the MRER 39 as it rotates so as to determine a speed of the wheel 300. This data can then used for anti-lock braking systems.

The elastomer portion 50 extends axially from the first end 43 of the SJSR 40 to and around the second end 44, terminating at a medial position to form a second sealing lip 54 on an underside of the SJSR 40. The second sealing lip 54 extends from a fold 46 that is formed at a medial axial position within the metal base portion 42. The second sealing lip 54 sealingly engages a radial outer surface 87 of the axial boss 85 so as to prevent contaminants and moisture from entering the axial face spline joint 98. Therefore, the SJSR 40 provides axially sealing via the first sealing lip 52 and radial sealing via the second sealing lip 54. In some example embodiments, the first sealing lip 52 is not needed and therefore can be removed from the SJSR. Additionally, via the fixation of the SJSR 40 to the wheel bearing 10 and the sealing engagement of the second sealing lip 54 to the CV joint 80, the SJSR 40 can also provide axial retention of the CV joint 80 to the wheel bearing 10.

In an example embodiment, a portion of an underside of the metal base portion 42 of the SJSR 40 is not covered with the elastomer portion 50, resulting in a bare metal surface. This bare metal surface is engaged with and attached to, via known seal attachment methods, to a radial outer surface 31 of the inner ring 30. In an example embodiment, the SJSR 40 is attached to the inner ring 30 via a press-fit. In an example embodiment, the second and third inner raceways 60B, 60C are integrated directly onto the hub 12 (eliminating the presence of the inner ring 30), and the SJSR 40 is attached to the hub 12 via a press-fit or any suitable attachment method. In a further example embodiment, the SJSR 40 is attached to the outer ring 34 instead of the inner ring 30 or hub 12.

The second end 44 of the SJSR 40, which could also be referred to as a distal end, limits a tilt angle A1 between the first and second central axes AX1, AX2 based on its proximity to the CV joint 80, or, particularly, its proximity to the tapered outer surface 88 of the CV joint 80. As shown in FIG. 4, in an example embodiment, the SJSR 40 can be designed to engage a landing 84 formed on the tapered outer surface 88; thus the second end 44 can form an abutment 58. In this configuration, the SJSR 40 is continuously engaged with the tapered outer surface 88, or the landing 84 thereof. This arrangement prevents or minimizes the tilt angle A1 between the first and second central axes AX1, AX2 during the assembly process. The SJSR 40, CV joint 80, and the wheel bearing 10 form an enclosed first annular space AS1. The SJSR 40 and CV joint 80 form an enclosed second annular space AS2.

Turning to FIG. 5, in a further example embodiment, an SJSR 40A can be designed to not engage the landing 84 but to extend so that the second end 44 is proximate to the landing 84. This proximity can be defined by a first axial gap AG1 and a first radial gap RG1. The extent or magnitude of these geometric openings can correspond to a pre-determined tilt angle A1 limit. In this design, a slight tilting occurs between the first and second central axes AX1, AX2 until the SJSR 40A engages a contact point CP1 on the tapered outer surface 88. This arrangement prevents excessive tilt between the first and second central axes AX1, AX2 that can be detrimental to the assembly process; excessive tilt can lead to misalignment and/or disengagement of the two axial face splines 20, 83.

In an example embodiment, the pre-determined tilt angle A1 limit resides within a tilt angle range of zero degrees to 35 degrees. Stated otherwise, the tilt angle A1 can be limited to zero degrees or any desired angle up to 35 degrees, as defined by at least one of the first radial gap RG1 and/or the first axial gap AG1. A magnitude of the first radial gap RG1 and/or the first axial gap AG1 can define the tilt angle A1. In an example embodiment, the tilt angle A1 is limited to an angle between one degree and twenty degrees. In an example embodiment, the tilt angle A1 is limited to an angle between one degree and fifteen degrees. In an example embodiment, the tile angle A1 is limited to angle between one degree and ten degrees. The tilt angle could also be described as a pivot angle and, thus the SJSR 40A limits pivoting of the CV joint 80 relative to the wheel bearing 10. Further, the SJSR 40A could be described as controlling a magnitude of tilt or controlling a rotational (or pivoting) play between wheel bearing 10 and the CV joint 80. For this disclosure, the terminology “pivotably retain” is used to describe a function of the SJSR 40 and is meant to signify that the SJSR 40 captures or secures both the wheel bearing 10 and the CV joint 80 in a way that controls or limits a relative pivoting angle between them.

Further within the assembly process, after the initial assembly is retained by the retaining ring 90 and the SJSR 40, 40A, a bolt 92 or fastener can be inserted within the through-bore 18 to axially clamp the second axial face spline 83 of the CV joint 80 to the first axial face spline 20 of the hub 12. Stated otherwise, external threads arranged on an end 93 of the bolt 92 engage internal threads formed within a bore 91 of the cylindrical nose 82, and a flange 96 of a head 94 of the bolt 92 engages an axial surface 28 of a counterbore 26 formed within the through-bore 18. Threaded installation of the bolt 92 provides fixation of the CV joint 80 to the wheel bearing 10 such that no axial, pivoting, or rotational movement occurs between these two components. The bolt can be concentric with the first central axis AX1. Before assembly of the bolt 92, axial retention and tilt limitation between the first and second axial face splines 20, 83 is ensured, respectively, via the retaining ring 90 and the SJSR 40.

The assembly of the wheel bearing 10 and the CV joint 80 (or joint element) can be summarized as follows:
Step 1: providing the wheel bearing 10, the SJSR 40, 40A (or a first retaining element), the CV joint 80, and the retaining ring 90 (or a second retaining element); the wheel bearing 10 includes the hub 12 and at least one outer raceway 62A, 62B, 62C that is radially offset from a corresponding at least one inner raceway 60A, 60B, 60C disposed on the hub 12 to define the rolling element space 48; the hub 12 includes the through-bore 18 and the first axial face spline 20; the CV joint 80 includes the second axial face spline 83;
Step 2: inserting the CV joint 80 into the through-bore 18 of the hub 12 so that: i) the second axial face spline 83 is non-rotatably engaged with the first axial face spline 20, ii) the retaining ring 90 locks the CV joint 80 to the through-bore 18 so as to axially retain the CV joint 80 to the wheel bearing 10; and, iii) an end of the SJSR 40, 40A is proximate to or engaged with the outer surface 88 of the CV joint 80 so as to pivotably retain the CV joint 80 to the CV joint 80; and
Step 5: fixing the wheel bearing 10 to the CV joint 80 via the bolt 92.

The previously described example embodiments of the SJSR 40, 40A can accomplish: i) sealing of the axial face spline joint 98 defined by the first and second axial face splines 20, 83, ii) control of, prevention of, or minimization of a tilt angle A1 between the first and second central axes AX1, AX2 of the wheel bearing and CV joint assembly 100, and iii) axial retention. Since the sealing and retention functions are accommodated by a single component, the spline joint seal and retainer can be described as an “integrated spline joint seal and retainer”, which signifies that one component is accomplishing both of these tasks.

The previously described example embodiments of the SJSR 40, 40A and the retaining ring 90, both of which can be non-threaded components, provide for a simple and inexpensive means of preventing disengagement of the axial face spline joint 98 before the bolt 92 is installed during an assembly process. The previously described CV joint 80 can be any joint element that includes an axial face spline that meshes or engages with the axial face spline 20 of the wheel bearing 10. Further, in an example embodiment, the SJSR 40, 40A and the retaining ring 90 can each be separate and distinct components from the described constituents of the wheel bearing 10 and CV joint 80.

While example embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A wheel bearing assembly, comprising:
a wheel bearing having:
a first central axis;
an inner ring;
an outer ring;
at least one row of rolling elements arranged within a rolling element space defined by the inner ring and the outer ring;
a first axial face spline; and
a first retaining element fixed to the wheel bearing;
a joint element having:
a second central axis;
a second axial face spline configured to non-rotatably engage the first axial face spline so as to form an axial face spline joint;
a second retaining element disposed radially between the joint element and the wheel bearing, the second retaining element configured to axially retain the wheel bearing to the joint element; and
the first retaining element configured to abut with the joint element so as to limit a tilt angle between the first central axis and the second central axis.

2. The wheel bearing assembly of claim 1, wherein the second retaining element is a retaining ring disposed radially between the wheel bearing and the joint element.

3. The wheel bearing assembly of claim 1, wherein the second retaining element springably couples the joint element to the wheel bearing.

4. The wheel bearing assembly of claim 1, wherein the second retaining element is arranged radially inwardly of the first retaining element.

5. The wheel bearing assembly of claim 1, wherein the first retaining element further comprises a sleeve, and an end of the sleeve is configured to abut with the joint element so as to limit the tilt angle between the first central axis and the second central axis.

6. The wheel bearing assembly of claim 1, wherein the first retaining element further comprises a first sealing lip configured to sealingly engage a radial surface of the joint element.

7. The wheel bearing assembly of claim 6, wherein the first retaining element further comprises a second sealing lip configured to sealingly engage an axial surface.

8. The wheel bearing assembly of claim 7, further comprising a magnetic encoder, and the magnetic encoder includes the axial surface.

9. The wheel bearing assembly of claim 1, further comprising a first seal arranged at an axial inner portion of the rolling element space, and a second seal is arranged at an axial outer portion of the rolling element space.

10. The wheel bearing assembly of claim 1, wherein the joint element further comprises a male portion disposed within a female portion of the wheel bearing and the second retaining element is disposed radially between the male portion and the female portion so as to axially retain the wheel bearing to the joint element.

11. The wheel bearing assembly of claim 1, further comprising a fastener configured to rotationally, pivotably and axially fix the wheel bearing to the joint element.

12. The wheel bearing assembly of claim 11, wherein the joint element is a constant velocity joint.

13. The wheel bearing assembly of claim 1, wherein a distal end of the first retaining element defines a gap with an outer surface of the joint element, and a magnitude of the gap defines a tilt angle between the first central axis and the second central axis.

14. A method of assembling a wheel bearing to a joint element, comprising:
providing:
a wheel bearing, comprising:
a hub configured to be attached to a wheel, the hub having a first axial face spline;
at least one row of rolling elements arranged within a rolling element space defined by an inner ring and an outer ring; and
a first retaining element fixed to the wheel bearing;
a joint element having a second axial face spline;
a second retaining element fixed to one of the hub or the joint element;
inserting the joint element into the hub so that:
the second axial face spline is non-rotatably engaged with the first axial face spline forming an axial face spline joint;
the second retaining element locks the joint element to the hub so as to axially retain the joint element to the hub; and
an end of the first retaining element is proximate to or engaged with an outer surface of the joint element so as to limit a tilt angle between a central axis of the joint element relative to a central axis of the wheel bearing; and
fixing the wheel bearing to the joint element via a fastener disposed within the hub.

15. The method of claim 14, wherein the wheel bearing further comprises:
a first seal arranged at an axial inner portion of the rolling element space; and
a second seal arranged at an axial outer portion of the rolling element space.

16. The method of claim 14, wherein the first retaining element and the second retaining element are non-threaded.

17. The method of claim 14, wherein the first retaining element comprises a first sealing lip configured to seal the axial face spline joint.

18. The method of claim 14, wherein the joint element further comprises a male portion disposed within a female portion of the hub, and the second retaining element is disposed radially between the male portion and the female portion so as to axially retain the joint element to the hub.

19. The method of claim 14, wherein the first retaining element is fixed to a ring of the wheel bearing, the ring comprising a raceway.

20. A wheel bearing assembly, comprising:
a wheel bearing having:
a first axial face spline; and
at least one row of rolling elements;
a joint element having a second axial face spline non-rotatably engaged with the first axial face spline;
a first retaining element configured to axially retain the joint element to the wheel bearing;
a second retaining element configured to limit a relative pivot motion between the joint element and the wheel bearing; and
a fastener fixing the joint element to the wheel bearing.
